(19) United States
(12) Patent Application Publication
(10) Pub. No.: US 2010/0265705 A1
(43) Pub. Date: Oct. 21, 2010

(54) LED lamp

(76) Inventors: NIEN-LU FANG, Luzhu Shiang (TW); HUNG-HSIANG CHIU, Luzhu Shiang (TW); MENG-HSIEN HONG, Luzhu Shiang (TW); JIAN-CHIH LO, Luzhu Shiang (TW); YI-LING TAI, Luzhu Shiang (TW)

Correspondence Address: PRO-TECHTOR INTERNATIONAL SERVICES, 20775 NORADA CT., SARATOGA, CA, 95070, US

(21) Appl. No.: 12/427,290

(22) Filed: Apr. 21, 2009

(51) Int. Cl. F21V 1/00; F21S 4/00

(52) U.S. Cl. 362/235; 362/249.06

(57) ABSTRACT

The present invention discloses a structure improvement of an LED lamp which is assembled by plural LED modules. Plural light scattering plates and plural reflectors on a lamp shade of the LED lamp can be covered respectively on the LED modules to scatter and reflect light emitted by the LEDs, such that uniformity and brightness of the lamp set can be improved, an electricity charge can be saved and the lamp set can be environmental friendly.

### BACKGROUND OF THE INVENTION

a) Field of the Invention

The present invention relates to an LED (Light Emitting Diode) lamp, and more particularly to an LED lamp which saves energy and is environmental friendly by being formed with a DIY (Do-It-Yourself) method through remodeling existing fluorescent tubes by utilizing LED modules, in association with light scattering plates and reflectors on a lamp shade.

b) Description of the Prior Art

An illuminating lamp set which is used most often in an existing public place like an office is assembled by plural fluorescent tubes. These fluorescent tubes contain mercury vapor and ultraviolet which will damage to biota and human bodies. In addition, as the fluorescent tubes are gaseous light tubes, starters must be used for actuating. However, along with that LED has been developed, due to that an LED solid-state light tube does not contain mercury and ultraviolet, the LED light tube is provided with features of soft light, energy saving and economic friendliness and has gradually replaced the conventional fluorescent tube. Nevertheless, a single power LED which is commonly used for illumination is provided with brightness of about 1-3 W and a driving current of about 350-900 mA, with light and heat being generated after being energized. Therefore, an aluminum substrate needs to be provided for heat dissipation. Accordingly, the power LED has a higher cost and consumes more electricity; hence, a mature LED lamp set has not yet been available on a market capable of replacing the conventional fluorescent tubes.

### SUMMARY OF THE INVENTION

The primary object of the present invention is to provide an LED lamp, wherein LED modules assembled by small-scale LEDs used in a backlit panel are utilized, in association with light scattering plates and reflectors on a lamp shade, to replace conventional fluorescent tubes by a DIY method, allowing an LED lamp-set to be provided with an improved uniformity and brightness, and even to be featured by soft light, energy-saving and environmental friendliness.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of an LED lamp of the present invention.

FIG. 2 shows a structural view of an LED lamp of the present invention, wherein a lamp shade is semi-opened.

FIG. 3 shows a bottom perspective view of a lamp shade of the present invention.

FIG. 4 shows a perspective view of a lamp holder of the present invention.

FIG. 4-1 shows a partial sectional view of a frame in FIG. 4 of the present invention.

FIG. 5 shows a partial structural view of a lamp shade of the present invention.

### DETAILED DESCRIPTION OF THE PREFERRED EMBODIMENTS

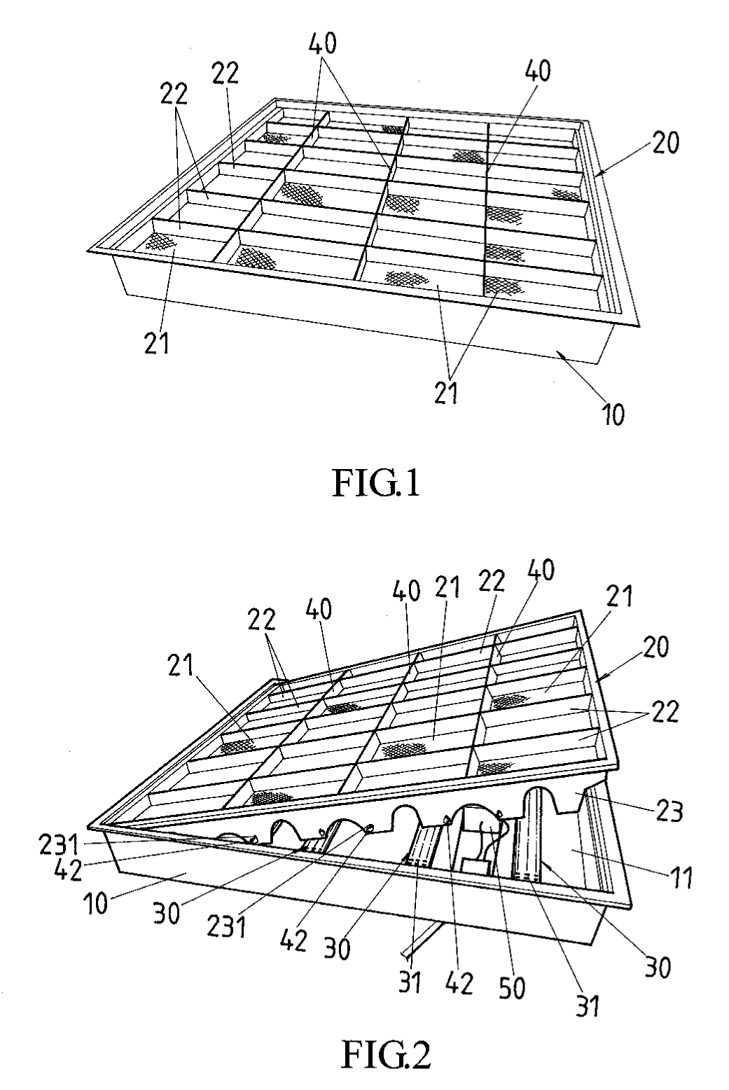

Referring to FIGS. 1 to 4, an LED lamp of the present invention comprises a lamp holder 10, a lamp shade 20, plural LED modules 30 and plural reflectors 40, wherein the lamp holder 10 is a rectangular concaved seat, an interior of which is provided with a chamber 11 for emplacing the plural LED modules 30 and a power supply 50, and each LED module 30 is formed by serially connecting plural LEDs 31 which are arranged tidily. The LEDs 31 are a small-scale LEDs used in a backlit panel, such as the LEDs used in a laptop computer or a backlit module. As those LEDs produce less heat, no additional aluminum substrate is required for heat dissipation. Furthermore, those LEDs save a lot of electricity (at least by 50% compared to the conventional fluorescent tube) and are provided with a lifetime of usage of about 50,000 hrs (the lifetime of usage of the conventional fluorescent tubes is about 2,000 hrs), therefore, it is not necessary to replace the tubes constantly.

The lamp shade 20 is provided with a same shape as that of the lamp holder 10, and can be covered in the chamber 11 of the lamp holder 10. A top surface of the lamp shade 20 is covered by plural light scattering plates 21 made by embossed acryl. The light scattering plates 21 are provided with effects of preventing from glare and preventing from silhouette, and are stopped by plural transversal partition plates 22. A front side and a rear side of the lamp shade 20 are provided respectively with a stop plate 23 on which is installed with a fastening hole 231.

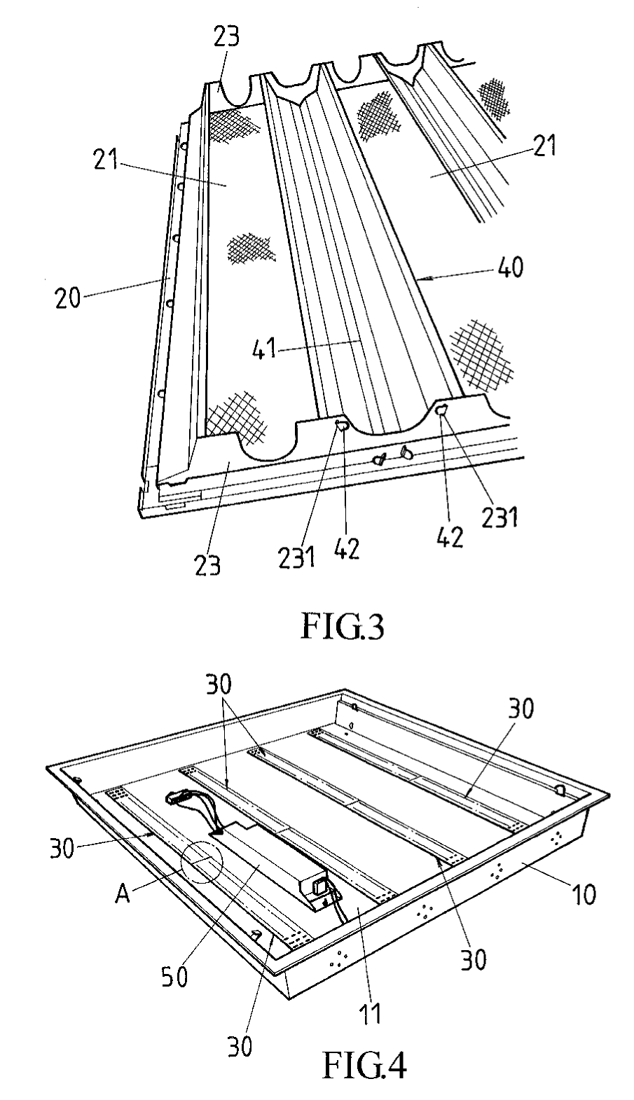

Referring to FIG. 3, the plural reflectors 40 are fixed respectively at a bottom of the lamp shade 20, and are interleaved with the partition plates 22 (as shown in FIG. 2). A surface of each reflector 40 is formed with an optical coating which can reflect light emitted by the LEDs 31 to enhance brightness of the lamp set. A center of the irregular arc-shape reflector 40 is provided with a groove 41 which can be covered on the LED module 30. In addition, a front end and a rear end of the reflector 40 are provided respectively with a hook 42 which can be hooked into the fastening hole 231 of the stop plate 23 for positioning.

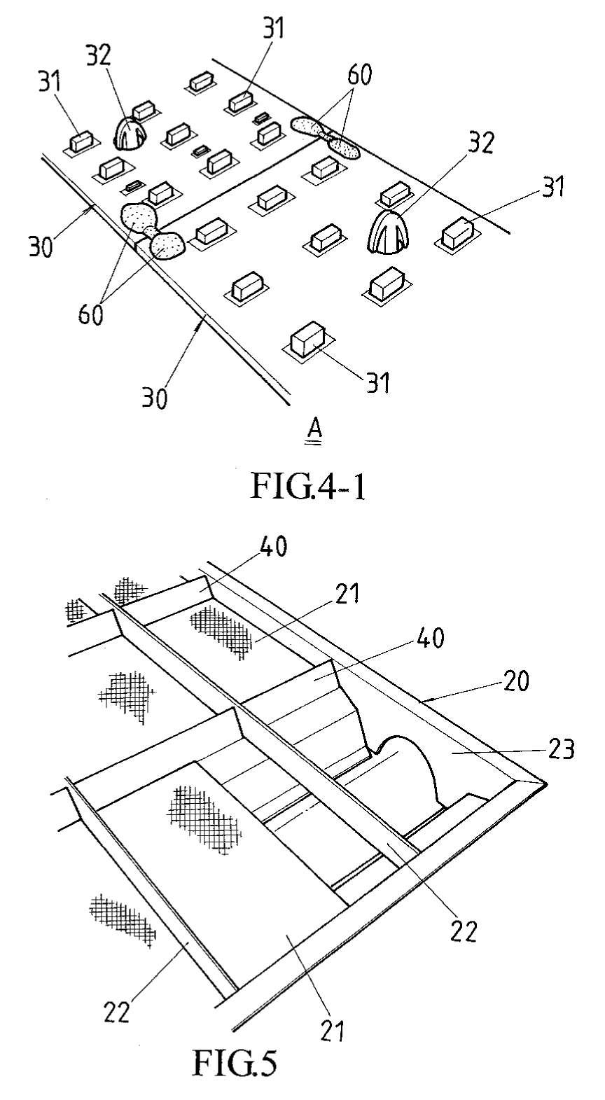

Referring to FIG. 4, in an interior of the lamp holder 10 of the present invention, two sets of serially connected LED modules 30 are emplaced in the chamber 11 after being arranged with a gap. On the other hand, for the lamp holder 10 and the chamber 11 of different lengths, plural serially connected LED modules can be aligned, as well. Referring to FIG. 4-1, the neighboring serially connected LED modules 30 are electrically connected by solder 60, and the LED modules 30 are fixed on the lamp holder 10 by plastic hooks 32; whereas, any LED module 30 is assembled by three rows of LEDs 31.

Referring to FIG. 5, gaps between the lamp shade 20 and the reflectors 40 (or neighboring reflectors 40) can be inserted and installed with the light scattering plates 21 by a user with a DIY method. The light scattering plates 21 are transfixed in the plural partition plates 22 to fix the light scattering plates 21. Another advantage of the present invention lies in that the user can also purchase by oneself the LED modules 30, the power supply 50 and the light scattering plates 21, dismantle first the conventional existing fluorescent tubes with the DIY method and then install the LED modules 30.

Conclusive from the above, in accordance with the present invention, the rectangular lamp shade, which is assembled by the conventional fluorescent tubes and is used commonly for the public place, like the office, is improved, and the conventional fluorescent tubes are replaced by the 5 LED modules. The LED lamp utilizes the small-scale LEDs used for the ordinary backlit panel, such as the LED lamp used for the laptop computer or the backlit module, which saves more energy and is environmental friendly, in addition to that the light is softer without offending eyes.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An LED lamp comprising a lamp holder, an interior of which is provided with a chamber; a lamp shade, a top surface of which is provided with light scattering plates, surfaces of the light scattering plates being provided with plural partition plates, and a front side and a rear side of the lamp shade being provided respectively with a stop plate; plural LED modules which are emplaced in the chamber of the lamp holder; and plural reflectors which are fixed respectively at a bottom of the lamp shade, a center of each reflector being provided with a groove covered on the LED module to reflect light emitted by the LEDs.

2. The LED lamp according to claim 1, wherein the stop plate of the lamp shade is provided with a fastening hole, a front end and a rear end of the reflector are provided respectively with a hook which is hooked in the fastening hole for positioning.

3. The LED lamp according to claim 1, wherein the reflector is in an irregular arc-shape.

4. The LED lamp according to claim 1, wherein the LED module is assembled by three rows of LEDs.
